(19) United States
(12) Patent Application Publication
(10) Pub. No.: US 2005/0075008 A1
(43) Pub. Date: Apr. 7, 2005

(54) POWER CONNECTOR HAVING LATCH DEVICES ON OPPOSITE SIDES AND AN ANTI-MISMATING STRUCTURE

(76) Inventor: William E. Spink JR., Laguna Niguel, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/677,575

(22) Filed: Oct. 1, 2003

(51) Int. Cl. H01R 13/60

(52) U.S. Cl. 439/575

(57) ABSTRACT

A connector assembly includes a header connector (10, 110) and a cable end connector (50) engageable with the header connector. The header connector includes an insulative housing (12, 112) defining a number of passageways (20, 120) and a number of conductive contacts (14, 114) each having a mating portion (24, 124) received in corresponding passageways and a tail portion (26, 126) extending below a bottom surface (16, 116) of the housing. The tail portions extend in a single plane parallel with the bottom surface of the housing such that they are surface mountable onto corresponding solder pads on the substrate. The housing provides a pair of wedgy blocks (30, 130) on opposite side surface (31, 131) thereof. The cable end connector includes a housing (52) providing a pair of latches (60) on opposite side surfaces (61) thereof. The latches engage with the wedgy blocks when the cable end connector completely mates with the header connector to avoiding disengagement of the connectors.

### BACKGROUND OF THE INVENTION

1. Field of the Invention

The present invention relates to a power connector having latching means on opposite sides thereof for securely engaging with a mating connector mounted on a substrate.

2. Description of the Related Art

U.S. Pat. No. 5,342,221 discloses a connector assembly including a board mounting connector and a cable end connector matable with each other. The board mounting connector may lie on a substrate and defines a plurality of passageways such that the board mounting connector is matable with the cable end connector in a direction parallel with the substrate. The cable end connector includes an insulative housing and a number of conductive contacts attached to the housing. The housing includes a front surface adapted for mating with the cable end connector and a rear surface distanced from the front surface. The housing provides a number of poles protruding forward from the front surface thereof and a plurality of terminals are held in the poles. The housing provides a latch on a top surface thereof that pivots at a generally medal section thereof connecting to the top surface. The mating connector provides a wedgy block on a top surface of a housing thereof adjacent a mating surface thereof which is engageable with the latch of the cable end connector to keep the connectors mated.

However, in some instance, due to the restriction of the space, the latch cannot be located on the top surface of the housing. Thus, the above mentioned connector assembly cannot be used in the instance where the space above the top surface of the housing is limited. So, it is desirable to design a new connector to meet this requirement.

### SUMMARY OF THE INVENTION

An object of the present invention is to provide a power connector having improved latching means for securely engaging the power connector with a mating connector.

To obtain the above object, a connector assembly includes a header connector and a cable end connector engageable with the header connector. The header connector includes an insulative housing defining a number of passageways and a number of conductive contacts each having a mating portion received in corresponding passageways and a tail portion extending below a bottom surface of the housing. The tail portions extend in a single plane parallel with the bottom surface of the housing such that they are surface mountable onto corresponding solder pads on the substrate. The housing provides a pair of wedgy blocks on opposite side surface thereof. The cable end connector includes a housing providing a pair of latches on opposite side surfaces thereof. The latches engage with the wedgy blocks when the cable end connector completely mates with the header connector to avoiding disengagement of the connectors.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a top perspective view of a header connector in accordance with a first embodiment of the present invention;

FIG. 2 is a perspective view of the header connector in FIG. 1 and a cable end connector before mated;

FIG. 3 is similar to FIG. 2 but the connectors are mated with each other and the header connector is mounted onto a substrate;

FIG. 4 is a bottom perspective view of a right angle header connector in accordance with a second embodiment of the present;

FIG. 5 is a perspective view of the right angle header connector in FIG. 4 the cable end connector in FIG. 2 before mated; and

FIG. 6 is similar to FIG. 5 but the connectors are mated with each other and the right angle header connector is mounted onto a substrate.

### DESCRIPTION OF THE PREFERRED EMBODIMENT

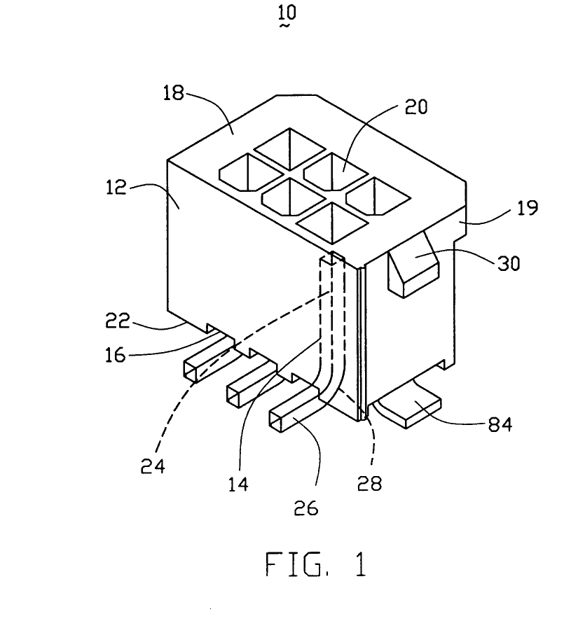

FIGS. 1-3 illustrate a first embodiment of a connector system including a header connector 10 and a cable end connector 50. The header connector 10 includes a housing of insulative material 12 and a number of contact of conductive material 14 assembled to the housing 12. The housing 12 has a bottom surface 16 facing a substrate 80 (sometimes called printed board) after the header connector 10 is mounted onto the substrate 80 and an opposite top surface 18 and defines a plurality of passageways 20 between the bottom and top surfaces 16, 18. These passageways 20 are arranged in rows, for example two rows and each row has three passageways 20. The passageways 20 impress at least two different geometries on the top surface 18 of the housing 12 such that there is a pole that may be inserted into the passages having one of the geometry but may not be inserted into the passages having the other geometry. Several stand-offs 22 are provided on the bottom surface 16 of the housing 12. Each contact 14 includes a contacting portion 24 at one end thereof, a tail portion 26 at another end thereof and an intermediate portion 28 between the contacting portion 24 and the tail portion 26. The contacting portions 24 are received in corresponding ones of the passageways 20, respectively. Bottom portions of the tail portions 26 are generally located in a single plane below and parallel with the bottom surface 16 of the housing 12 such that the tail portions 26 are surface mountable onto solder pads 82 of the substrate 80. A pair of conductive panels 84 are respectively assembled to two opposite elongate ends of the housing 12 and each has a section downward extending beyond the bottom surface 16 to the single plane that bottom portions of the tail portions 26 are located in. The conductive panels 84 are surface mountable onto solder pads 86 on the substrate 80 to secure the header connector 10 in position.

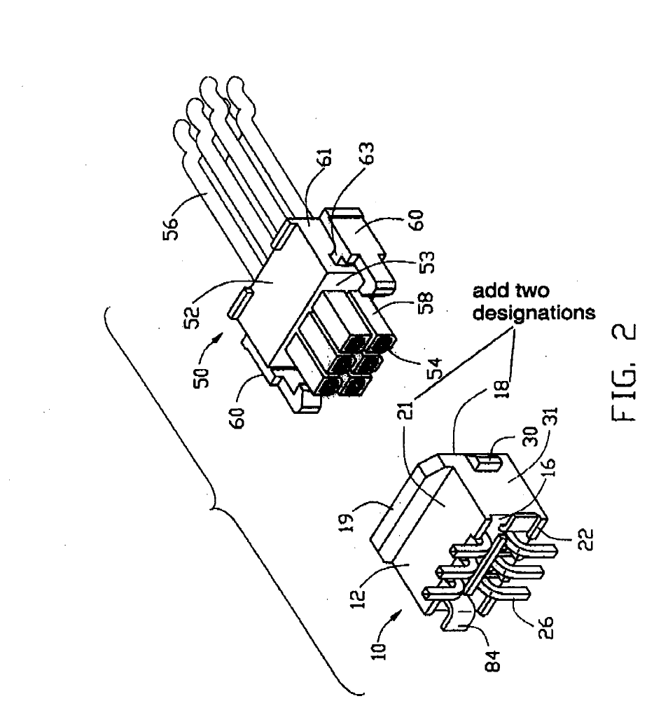

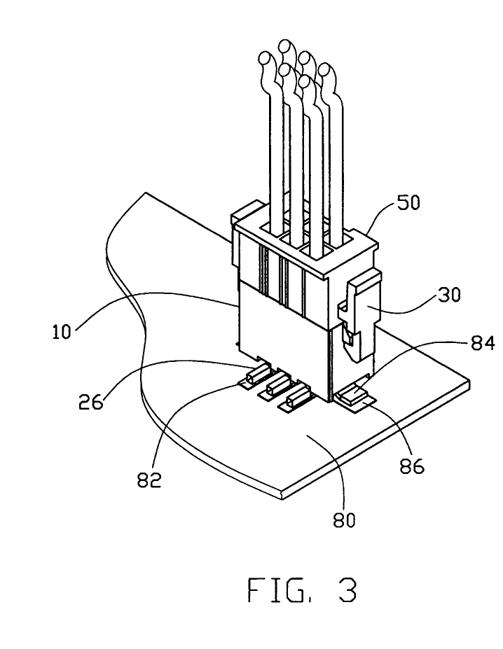

Referring to FIGS. 2 and 3, the cable end connector 50 includes a housing of insulative material 52, a plurality of contacts of conductive material 54 retained in the housing 52 and a corresponding number of wires 56 electrically connecting to corresponding ones of the contacts 54. The housing 52 provides a number of poles 58 extending forward from a front surface 53 thereof. The poles 58 are arranged in two rows and each row has three poles. The poles 58 are configured in accordance with the geometries imposed on the top surface 18 by the passageways 20 such that the cable end connector 50 is engageable with the header connector 10. The housing 52 of the cable end connector 50 provides a pair of latches 60 respectively connecting to opposite side surfaces 61 thereof at pivotal points 63 thereof. When operated, the latches 60 pivot around the pivotal points 63 to engage with or disengage from wedgy blocks 30 on opposite side surfaces 31 of the header connector 10. The housing 12 provides an elongate wall 19 on a top surface 21 thereof at the cross of the top surface 21 and the front surface 16 of the housing 12. The elongate wall 19 works as a barrier to prevent a cable end connector with a latch on a top surface thereof, as disclosed in the U.S. Pat. No. 5,642,221, from engaging with the header connector 10.

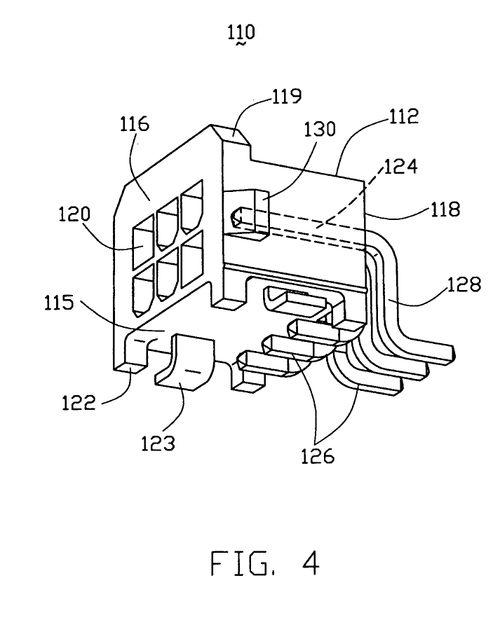

FIGS. 4-6 illustrate a second embodiment of the connector system including a right-angle header connector 110 and the cable end connector 50 disclosed above. The header connector 110 is similar to the header connector 10 but the header connector 10 “stands” on the substrate 80 and engages with the cable end connector in a direction perpendicular to the substrate 80 while the header connector 110 “lies” on the substrate 80 and engages with the cable end connector in a direction parallel with the substrate 80. The header connector 110 includes a housing 112 of insulative material, a plurality of contacts 114 of conductive material attached to the housing 112. The housing 112 has a bottom surface 115 facing the substrate 80 when the header connector 110 is mounted onto the substrate, a front surface 116 engageable with the cable end connector 50, a rear surface 118 distanced from the front surface 116 and defines a plurality of passageways 120 between the front and rear surfaces 116, 118. The housing provides four stand-offs 122 on the bottom surface 115 thereof. Each contact 114 includes a contacting portion 124 at one end thereof, a tail portion 126 at another end thereof and an intermediate portion 128 between and connecting the contacting portion 124 to the tail portion 126. The contacting portions 124 are received in corresponding ones of the passageway 120 while the intermediate portions 128 extend rearward beyond the rear surface 118 such that the tail portions 126 locate out of the housing. The tail portions 126 are arranged in two rows, and one row of the tail portions 126 reversely extend toward the front surface 116 of the housing 112 under the bottom surface 115 but the other row of tail portions 126 rearward extend further away from the front surface 116 such that the one row of tail portions 126 are closer to the front surface 116 than the other row of tail portions 126. All the tail portions 126 locate in a single plane (not labeled) such that they are solderable onto the substrate 80. A pair of conductive panels 123 is respectively attached to two opposite elongate ends of the housing 112 each having a section downward extending below the bottom surface 115 of the housing into the single plane. The housing provides a pair of wedgy blocks 130 on opposite side surfaces 131 adjacent the front surface 116 thereof. The wedgy blocks 130 are engageable with the latches 60 of the cable end connector 50. The housing 112 provides an elongate wall 119 on a top surface 121 thereof at the cross of the top surface 121 and the front surface 116 of the housing 112. The elongate wall 119 works as a barrier to prevent a cable end connector with a latch on a top surface thereof, as disclosed in the U.S. Pat. No. 5,642,221, from engaging with the header connector 110.

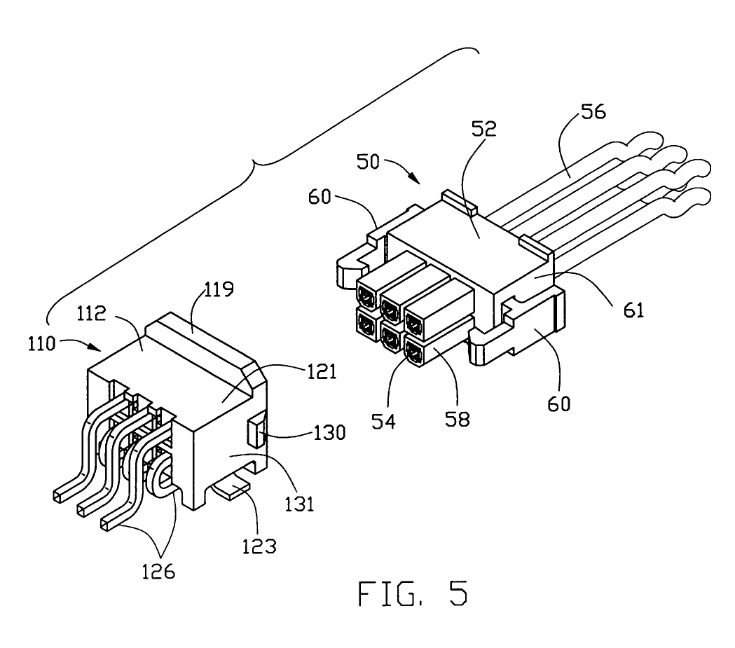

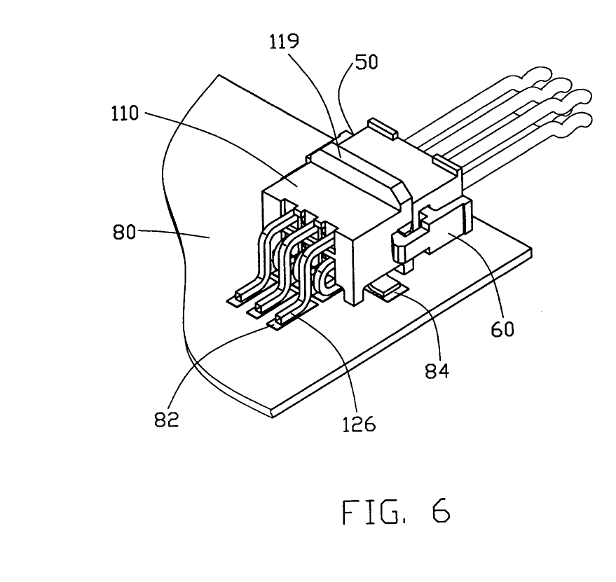

Referring to FIGS. 5 and 6, the cable end connector 50 is matable with the header connector 110 in a direction parallel with the substrate 80 that the header connector 110 mounts on. The latches 60 engage the wedgy blocks 130 when the cable end connector 50 completely mates with the header connector 110 to prevent disengagement of the cable end connector 50 from the header connector 110 due to vibration.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1-2. (canceled)

3. An electrical connector assembly, comprising:
a cable end connector, the cable end connector including an insulative housing and a plurality of conductive terminals connected with respective wires, the housing providing a plurality of poles protruding forward from a front surface thereof and a pair of latches respectively connecting to opposite side surfaces thereof at pivotal points, the terminals being housed in the housing and extending to free ends of the poles with the wires extending rearward beyond a rear surface of the housing; and
a header connector, the header connector including an insulative housing and a plurality of contacts housed in the housing, the housing defining a plurality of passageways receiving respective ones of the poles of the cable end connector and the terminals connecting with the respective contacts, the housing providing a pair of wedgy blocks on opposite side surfaces thereof, the wedgy blocks engaging with the latches when the cable end connector completely mates with the header connector, the housing of the header connector having a mating surface to mate with the cable end connector and providing an elongate wall on a top surface thereof, and wherein the elongate wall has a surface locating in the same plane as the mating surface.

4. (canceled)

5. The electrical connector assembly as recited in claim 3, wherein the contacts of the header connector each has a tail portion extending out of the housing of the header connector and in a plane parallel with a bottom surface of the housing, such that the contact tail portions are surface mountable onto conductive pads on a substrate.

6. (canceled)

7. The electrical connector assembly as claimed in claim 5, wherein the header connector comprises a pair of conductive panels respectively assembled to two opposite elongate ends of the header housing, the panels each having a section extending beyond and parallel to the bottom surface of the housing.

8-10. (canceled)
